(19) United States
(12) Patent Application Publication
(10) Pub. No.: US 2026/0188666 A1
(43) Pub. Date: Jul. 2, 2026

(54) POSITIVE ELECTRODE ACTIVE MATERIAL WITH COMBINATION OF LARGE AND SMALL PARTICLES, AND PREPARATION METHOD THEREFOR

(71) Applicants: BASF SHANSHAN BATTERY MATERIAL (NINGXIANG) CO. LTD., Hunan (CN); BASF SE, Ludwigshafen am Rhein (DE)

(72) Inventors: Piao NING, Hunan (CN); Bo TANG, Hunan (CN); Jun TANG, Hunan (CN); Shu Hui LIU, Hunan (CN); Gui LUO, Hunan (CN)

(21) Appl. No.: 19/131,561

(22) PCT Filed: Jan. 23, 2024
(86) PCT No.: PCT/CN2024/073666

§ 371 Date: May 21, 2025

(30) Foreign Application Priority Data
Nov. 30, 2022 (CN) 202211529333.4

(51) Int. Cl. H01M 4/525; C01G 53/506; H01M 4/02; H01M 4/131

(52) U.S. Cl. CPC H01M 4/525; C01G 53/506; H01M 4/131; C01P 2004/03; C01P 2004/51; C01P 2006/40; H01M 2004/021; H01M 2004/028

(57) ABSTRACT

Disclosed herein is a positive electrode active material with a combination of large and small particles, including large-particle secondary spheres and small-particle secondary spheres, where the mass ratio of the large-particle secondary spheres is not smaller than 50%; the D50 particle size of the large-particle secondary spheres is 10-20 μm, and the D50 particle size of the small-particle secondary spheres is 2-5 μm. The doping elements and nickel contents of large and small particles are strictly regulated to ultimately obtain a positive electrode material with good comprehensive performance in terms of capacity, cycling, and DCR. Also disclosed herein is a preparation method for the positive electrode active material with a combination of large and small particles.

### TECHNICAL FIELD

The present invention relates to the field of lithium-ion batteries, in particular to a positive electrode active material with a combination of large and small particles and a preparation method thereof.

### BACKGROUND

In the industry, the compaction densities of lithium-ion batteries are increased generally by combining large and small particles to prepare electrode plates, thus further improving energy densities, but when large secondary particles and small secondary particles, which have different characteristics, are subjected to heat treatment simultaneously, small secondary particles may be excessively calcined or large secondary particles may be insufficiently calcined, leading to performance degradation. Therefore, with a conventional calcination method, large and small secondary particles are heat-treated separately, and heat-treated particles are mixed for further heat treatment. The need for multiple heat treatment processes makes the process of preparing positive electrode active substances complex and increases manufacturing costs.

Chinese patent document CN114447289A discloses the co-sintering of large and small particles, wherein the large particles of the secondary sphere contain Al and the small particles thereof contain Mn, and the Mn content of the large particles is lower than that of the small particles; the conditions for sintering the material are controlled by changes in precursor element content, and manganese is coated on the surface of each large secondary particle, while aluminum is coated on the surface of each small secondary particle. Chinese patent document CN113823774A discloses that when the difference in Mn concentration between large and small particles is smaller than 2, any differences in sintering between the large and small particles in the material during the co-sintering process are preventable by adjusting the sintering temperature by the difference in Mn concentration. The above two patent documents both address the issue of how to, by using changes in Mn element, adjust large and small particles exhibiting different characteristics when sintered simultaneously, wherein Mn is essential, but it is not suitable for an NCA product or any other product that does not need to contain Mn element, which limits its scope of application.

Chinese patent document CN107785550A discloses a low-temperature coating pre-treatment process before co-sintering, which requires complex operations. Chinese patent document CN113394385A discloses in-situ coating of the precursor with a larger particle size and pre-oxidization of the precursor with a smaller particle size before co-sintering. In both of the above patents, multiple processes need to be carried out, which increases the complexity of the actual production process and increases the difficulty of operation in actual production.

Moreover, due to the difference in particle size, large and small particles have respective advantages and disadvantages in performance. For small particles, cycling performance needs to be improved, while for large particles, capacity characteristics need to be improved, and, at the same time, DCR issues need to be considered for performance improvement, wherein, in the event of a combination of large and small particles, it is necessary to minimize the DCR. Therefore, in the process of preparing a positive electrode material with a combination of large and small particles, it is necessary to improve the capacity and cycling performance of the material, while reducing the DCR of the material.

### SUMMARY OF THE INVENTION

A technical problem to be solved by the present invention is how to, by overcoming the above shortcomings and defects of the background art, provide a positive electrode active material with good capacity and cycling performance, and provide a preparation method that achieves co-sintering of large and small particles to meet the requirements for material characteristics, while reducing costs and allowing simple operations.

To solve the above technical problem, a technical solution proposed by the present invention is: a positive electrode active material with a combination of large and small particles, comprising large-particle secondary spheres and small-particle secondary spheres, wherein the mass ratio of large-particle secondary spheres in the positive electrode active material is not smaller than 50%;
a chemical formula of the large-particle secondary spheres is Li_{z} Ni_{b}M_{c}M′_{d}O₂, wherein M is one or more of Co, Mn, and Al, M′ is a doping element, and M′ is selected from one or more of Zr and Sr, 0.9≤a≤1.2, 0.7≤b<1, 0<c≤0.3, 0<d≤0.1;
a chemical formula of the small-particle secondary spheres is LiₑNi_{f}M_{g}M″ₕO₂, wherein M is one or more of Co, Mn, Al, M″ is a doping element, and M″ is selected from one or more of B, W, Mo, In, Ta, S, 0.9≤e≤1.2, 0.7≤f<1, 0<g≤0.2, 0<h≤0.1;
a D50 particle size of the large-particle secondary spheres is 10-20 μm, and a D50 particle size of the small-particle secondary spheres is 2-5 μm.

In the positive electrode active material with a combination of large and small particles as described above, preferably, the mass ratio of the large-particle secondary spheres to the small-particle secondary spheres is (7:3)-(9:1).

Preferably, the f and b satisfy: f>b, and f−b<0.1. Within this range, increasing the Ni content in the small particle is more beneficial for the DCR of the co-sintered secondary spheres with a combination of large and small particles.

Preferably, the positive electrode active material is obtained by co-sintering a precursor of the large-particle secondary spheres and a precursor of the small-particle secondary spheres, with doping elements M′ and M″ added during the preparation process of the precursor.

On the basis of a general inventive concept, the present invention further provides a preparation method of a positive electrode active material with a combination of large and small particles, comprising the steps of:
(1) mixing metal-salt solutions corresponding to the large-particle secondary spheres and the small-particle secondary spheres respectively with the metal-salt solutions corresponding to a precipitant, a complexing agent, and a doping element for a coprecipitation reaction, and then filtering and drying the mixture to prepare a large-particle secondary sphere precursor containing the doping element M′ and a small-particle secondary sphere precursor containing the doping element M″, respectively;
(2) mixing the large-particle secondary sphere precursor and small-particle secondary sphere precursor with a lithium source to obtain a mixture, and sintering the mixture to obtain a positive electrode active material with a combination of the large and small particles.

With the above preparation method, preferably, in step (1), all of the metal-salt solutions corresponding to the large-particle secondary spheres and the small-particle secondary spheres comprise a nickel salt and an M salt; the precipitant comprises one or more of sodium hydroxide and potassium hydroxide; the complexing agent comprises one or more of ammonia solution, ammonium sulfate, and ammonium bicarbonate.

Preferably, in step (1), the conditions for the coprecipitation reaction are that all the solutions are added to a reaction vessel at a rate of 0.1-10 L/h, with a pH of 9-12, a temperature of 40-80° C., and a stirring speed of 300-600 rpm during the reaction process.

Preferably, in step (2), the lithium source is selected from one or more of lithium carbonate, lithium hydroxide, and lithium nitrate; the molar ratio of metal elements in the lithium source to the total metal elements in the precursors of large and small secondary spheres is (0.9-1.2):1. Preferably, in step (2), the sintering has a temperature of 500-1000° C.

More preferably, the sintering specifically comprises the steps of:
S1, placing the mixture in an oxygen atmosphere for primary sintering, first sintering the mixture at 400-550° C. for 1-3 hours, then heating it up at 1-5° C./min to 600-800° C. for sintering for 8-20 hours, and, after cooling, passing it through a 300-mesh sieve to obtain a primary sintered product;
S2, washing, filtering, and drying the primary sintered product, placing it in an oxygen atmosphere for a second sintering, with a sintering temperature of 300-700° C. and a holding time of 3-20 hours, and, after cooling, passing it through a 300-mesh sieve to obtain a positive electrode active material with a combination of large and small particles.

Doping elements capable of producing different effects in the precursors of large-particle secondary spheres and small-particle secondary spheres can improve the problem of temperature difference when a material is sintered, wherein an element capable of increasing the size of the sintered primary particles may be doped in the precursor of large particles, while an element capable of reducing the size of the sintered primary particles may be doped in the precursor of small particles, so the above method allows the primary particles contained in the finally sintered secondary spherical particles to have the same size or similar sizes, so that two types of precursors with different nickel contents may be co-sintered.

The size of primary particles in secondary spherical particles provides a method for directly determining whether the sintering temperature is appropriate, and a material delivers the best performance only if its primary particles have an appropriate size. Usually, large-particle and small-particle secondary spheres have the same primary particle size only when the actual sintering temperature of large particles is higher than the sintering temperature of small particles, wherein, if the primary particle size is too large, the path size of Li ion migration may be affected, while if the primary particle size is too small, the material may have incomplete crystallinity when sintered. By doping different elements in the precursors of large and small particles, the performance of the material may be improved and the sintering process may be simplified, and doping elements in the precursors is conducive to a more uniform distribution of internal elements in the material, which helps the material deliver performance more uniformly and reduces polarization during the charging and discharging processes.

Compared with the prior art, the present invention has the following beneficial effects:
1. With a positive electrode active material with a combination of large and small particles of the present invention, large-particle secondary spheres and small-particle secondary spheres are doped with elements beneficial for compensating for respective shortcomings, wherein the precursor of small particles is doped with an element beneficial for improving the cycling performance of small particles and the precursor of large particles is doped with an element capable of enhancing the capacity, which cooperate to balance the capacity and cycling performance, further increasing the Ni content of small-particle secondary spheres, wherein, although the proportion of small particles is not high, the increase in Ni content thereof has a significant effect on reducing the overall DCR of the material; in summary, in the present invention, the doping elements and nickel contents of large and small particles are strictly regulated to ultimately obtain a positive electrode material that delivers high comprehensive performance in terms of capacity, cycling, and DCR.
2. With a preparation method of the present invention, the size of primary particles of a sintered material is controllable by doping different elements in the precursor stage, and the requirement that large and small particles have the same sintering temperature in the co-sintering process is indirectly met, so the material obtained by co-sintering large and small particles can deliver better performance; thus, large and small particles may be co-sintered to meet the requirements for material characteristics, without the need for any specific elements, which has a wide range of applications, while allowing simple operations to reduce costs.

### BRIEF DESCRIPTION OF THE DRAWING

To illustrate more clearly technical solutions provided in embodiments of the present invention or in the prior art, the accompanying drawings for explaining the embodiments or the prior art will be described briefly below, wherein, apparently, the drawings in the following description are only some embodiments of the present invention, and those of ordinary skill in the art can derive other drawings from these drawings without creative effort.

FIG. 1 is an SEM image of a positive electrode active material obtained by co-sintering large and small particles in embodiment 1.

FIG. 2 is an SEM image of a positive electrode active material obtained by co-sintering large and small particles in embodiment 2.

FIG. 3 is an SEM image of the positive electrode active material obtained by co-sintering large and small particles in comparative example 1.

FIG. 4 is an SEM image of the positive electrode active material obtained by co-sintering large and small particles in comparative example 2.

### EXAMPLE

For a better understanding of the present invention, the present invention will be described below more comprehensively and in greater detail in conjunction with the drawings and preferred embodiments, but the scope of protection of the present invention is not limited to the specific examples described below.

Unless otherwise defined, all the technical terms as used herein have the same meanings as those commonly understood by those of ordinary skill in this art. The technical terms as used herein are only for the purpose of describing specific embodiments, rather than being intended to limit the scope of protection of the present invention.

Unless otherwise specified, various raw materials, reagents, instruments, and devices used in the present invention are commercially available or may be prepared by existing methods.

### Example 1

A positive electrode active material with a combination of large and small particles, comprising large-particle secondary spheres and small-particle secondary spheres, wherein the chemical formula of the large-particle secondary spheres is Li_{1.05}Ni_{0.9}Co_{0.08}Al_{0.02}Zr_{0.0}O₂O₂ and the chemical formula of the small-particle secondary spheres is Li_{1.05}Ni_{0.92}Co_{0.06}Al_{0.02}B_{0.0005}O₂, which was prepared by the following steps:
(1) A nickel sulfate solution and a cobalt sulfate solution were mixed, a sodium aluminate solution dissolved in a sodium hydroxide solution, a zirconium sulfate solution, an ammonia solution with a concentration of 0.2 mol/L, and a sodium hydroxide solution with a concentration of 5.5 mol/L were added and fed into a reactor at a rate of 2.0 L/h for reaction, with a pH of 11, a temperature of 60° C., and a stirring speed of 400 rpm during the reaction process, wherein the metal molar ratio of Ni to Co to Al was 0.9:0.08:0.02 and the molar weight of Zr was 0.2 mol %, and, after aging, centrifugation, and drying, a large-particle precursor with a D50 particle size of 16 μm was obtained. The small-particle precursor was synthesized by the same method as the large-particle precursor, but in the metal molar ratio of Ni to Co to Al being 0.91:0.07:0.02, no zirconium sulfate solution was added, but a boric acid solution was added instead, in the preparation process, with element B having a molar weight of 0.05 mol %, wherein, when the D50 particle size reached 2.9 μm, the reaction was stopped and a small-particle precursor was obtained by post-treatment.
(2) Large-particle precursor Ni_{0.9}Co_{0.08}Al_{0.02}(OH)₂ doped with 0.2 mol % element Zr and small-particle precursor Ni_{0.92}Co_{0.06}Al_{0.02}(OH)₂ doped with 0.05 mol % element B were weighed in a mass ratio of 7.5:2.5, the two precursors were mixed with lithium hydroxide in a high-speed mixer in a metal molar ratio of 1:1.05, and the mixture was placed in an oxygen-atmosphere furnace for primary sintering, wherein the mixture was first sintered at 400° C. for 3 hours and then heated to 710° C. for sintering for 12 hours, at a heating rate of 5° C./min, and a matrix material was obtained after natural cooling; the sintered sample was passed through a 300-mesh sieve to obtain a primary sintered product, which was then water-washed; the prepared material, when washed, was stirred with an electric stirrer, washed in a ratio of 1:1 with deionized water for 30 minutes and then filtered, and the filter cake was placed in a vacuum drying oven for drying for 10 hours; after washing and drying, the sample was subjected to secondary sintering and then cooled naturally in an oxygen-atmosphere furnace at 650° C. for 6 hours, and the cooled sample was passed through a 300-mesh sieve to obtain a positive electrode material with a high compaction density.

As shown in FIG. 1, different elements were doped in large and small secondary spherical particles in the precursor, wherein, after being co-sintered, the large and small particles had similar primary particle sizes.

### Example 2

A positive electrode active material with a combination of large and small particles, comprising large-particle secondary spheres and small-particle secondary spheres, wherein the chemical formula of the large-particle secondary spheres is Li_{1.03}Ni_{0.9}Co_{0.05}Mn_{0.05}Sr_{0.0013}O₂ and the chemical formula of the small-particle secondary spheres is Li_{1.03}Ni_{0.91}Co_{0.04}Mn_{0.05}B_{0.001}O₂, which was prepared by the following steps:
(1) A nickel sulfate solution, a cobalt sulfate solution, a manganese sulfate solution, a strontium hydroxide solution, an ammonia solution with a concentration of 0.2 mol/L, and a sodium hydroxide solution with a concentration of 6.0 mol/L were fed into a reactor at a rate of 2.0 L/h for reaction, with a pH of 11, a temperature of 60° C., and a stirring speed of 350 rpm during the reaction process, wherein the metal molar ratio of Ni to Co to Mn was 0.9:0.05:0.05 and the molar weight of Sr was 0.13 mol %, and, after aging, centrifugation, and drying, a large-particle precursor with a D50 particle size of 14.5 μm was obtained. The small-particle precursor was synthesized by the same method as the large-particle precursor, but in the metal molar ratio of Ni to Co to Mn being 0.91:0.04:0.05, no strontium hydroxide solution was added, but a boric acid solution was added instead, in the preparation process, with element B having a molar weight of 0.1 mol %, wherein, when the D50 particle size reached 3.1 μm, the reaction was stopped and a small-particle precursor was obtained by post-treatment.
(2) Large-particle precursor Ni_{0.9}Co_{0.05}Mn_{0.05}(OH)₂ doped with 0.13 mol % element Sr and small-particle precursor Ni_{0.91}Co_{0.04}Mn_{0.05}(OH)₂ doped with 0.05 mol % element B were weighed in a mass ratio of 7:3, the two precursors were mixed with lithium hydroxide in a high-speed mixer in a metal molar ratio of 1:1.03, and the mixture was placed in an oxygen-atmosphere furnace for primary sintering, wherein the mixture was first sintered at 400° C. for 3 hours and then heated to 750° C. for sintering for 12 hours at a heating rate of 5° C./min, and a matrix material was obtained after natural cooling; the sintered sample was passed through a 300-mesh sieve to obtain a primary sintered product, which was then water-washed; the prepared material, when washed, was stirred with an electric stirrer, washed in a ratio of 1:1 with deionized water for 30 minutes and then filtered, and the filter cake was placed in a vacuum drying oven for drying for 10 hours; after washing and drying, the sample was subjected to secondary sintering and then cooled naturally in an oxygen-atmosphere furnace at 500° C. for 6 hours, and the cooled sample was passed through a 300-mesh sieve to obtain a positive electrode material with a high compaction density.

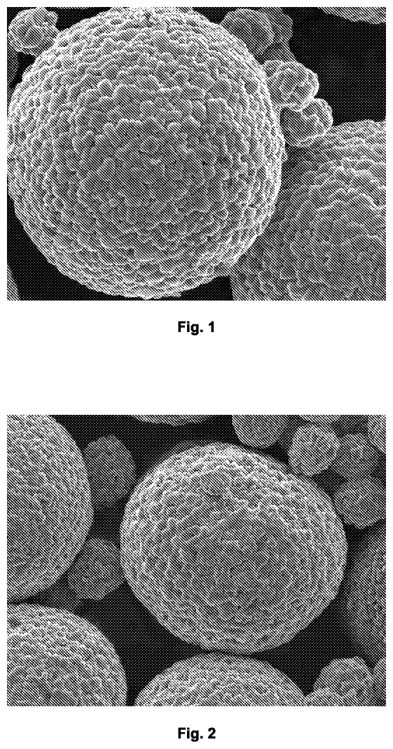

As shown in FIG. 2, different elements were doped in large and small secondary spherical particles in the precursor, wherein, after being co-sintered, the large and small particles had similar primary particle sizes.

### Example 3

A positive electrode active material with a combination of large and small particles, comprising large-particle secondary spheres and small-particle secondary spheres, wherein the chemical formula of the large-particle secondary spheres is Li_{1.03}Ni_{0.9}Co_{0.07}Al_{0.03}Sr_{0.001}O₂ and the chemical formula of the small-particle secondary spheres is Li_{1.03}Ni_{0.91}Co_{0.06}Al_{0.03}W_{0.0005}O₂, which was prepared by the following steps:
(1) A nickel sulfate solution and a cobalt sulfate solution were mixed, a sodium aluminate solution dissolved in a sodium hydroxide solution, a strontium hydroxide solution, an ammonia solution with a concentration of 0.2 mol/L, and a sodium hydroxide solution with a concentration of 5.5 mol/L were added and fed into a reactor at a rate of 2 L/h for reaction, with a pH of 11.8, a temperature of 60° C., and a stirring speed of 400 rpm during the reaction process, wherein the metal molar ratio of Ni to Co to Al was 0.9:0.07:0.03 and the molar weight of strontium was 0.1 mol %, and, after aging, centrifugation, and drying, a large-particle precursor with a D50 particle size of 14.5 μm was obtained. The small-particle precursor was synthesized by the same method as the large-particle precursor, but in the metal molar ratio of Ni to Co to Al being 0.91:0.06:0.03, no strontium-containing solution was added, but a sodium tungstate solution was added instead, in the preparation process, with element W having a molar weight of 0.05 mol %, wherein, when the D50 particle size reached 3.2 μm, the reaction was stopped and a small-particle precursor was obtained by post-treatment.
(2) Large-particle precursor Ni_{0.9}Co_{0.07}Al_{0.03}(OH)₂ doped with 0.1 mol % element Sr and small-particle precursor Ni_{0.91}Co_{0.06}Al_{0.03}(OH)₂ doped with 0.05 mol % element W were weighed in a mass ratio of 7:3, the two precursors were mixed with lithium hydroxide in a high-speed mixer in a metal molar ratio of 1:1.03, and the mixture was placed in an oxygen-atmosphere furnace for primary sintering, wherein the mixture was first sintered at 400° C. for 3 hours and then heated to 715° C. for sintering for 12 hours at a heating rate of 5° C./min, and a matrix material was obtained after natural cooling; the sintered sample was passed through a 300-mesh sieve to obtain a primary sintered product, which was then water-washed; the prepared material, when washed, was stirred with an electric stirrer, washed in a ratio of 1:1 with deionized water for 30 minutes and then filtered, and the filter cake was placed in a vacuum drying oven for drying for 10 hours; after washing and drying, the sample was subjected to secondary sintering and then cooled naturally in an oxygen-atmosphere furnace at 630° C. for 6 hours, and the cooled sample was passed through a 300-mesh sieve to obtain a positive electrode material with a high compaction density.

### Example 4

A positive electrode active material with a combination of large and small particles, comprising large-particle secondary spheres and small-particle secondary spheres, wherein the chemical formula of the large-particle secondary spheres is Li_{1.03}Ni_{0.9}Co_{0.07}Al_{0.03}Zr_{0.0015}O₂ and the chemical formula of the small-particle secondary spheres is Li_{1.03}Ni_{0.92}Co_{0.05}Al_{0.03}W_{0.001}Ti_{0.001}O₂, which was prepared by the following steps:
(1) A nickel sulfate solution and a cobalt sulfate solution were mixed, a sodium aluminate solution dissolved in a sodium hydroxide solution, a zirconium sulfate solution, an ammonia solution with a concentration of 0.2 mol/L, and a sodium hydroxide solution with a concentration of 5.0 mol/L were added and fed into a reactor at a rate of 2.2 L/h for reaction, with a pH of 11, a temperature of 55° C., and a stirring speed of 400 rpm during the reaction process, wherein the metal molar ratio of Ni to Co to Al was 0.9:0.07:0.03 and the molar weight of zirconium was 0.15 mol %, and, after aging, centrifugation, and drying, a large-particle precursor with a D50 particle size of 14.5 μm was obtained. The small-particle precursor was synthesized by the same method as the large-particle precursor, but in the metal molar ratio of Ni to Co to Al being 0.91:0.06:0.03, no zirconium sulfate solution was added, but a sodium tungstate solution and a titanic acid solution were added simultaneously instead, in the preparation process, with element W having a molar weight of 0.1 mol % and element Ti having a molar weight of 0.1 mol %, wherein, when the D50 particle size reached 3.2 μm, the reaction was stopped and a small-particle precursor was obtained by post-treatment.
(2) Large-particle precursor Ni_{0.9}Co_{0.07}Al_{0.03}(OH)₂ doped with 0.15 mol % element Zr and small-particle precursor Ni_{0.92}Co_{0.05}Al_{0.03}(OH)₂ doped with 0.1 mol % element W and 0.1 mol % Ti were weighed in a mass ratio of 7:3, the two precursors were mixed with lithium hydroxide in a high-speed mixer in a metal molar ratio of 1:1.03, and the mixture was placed in an oxygen-atmosphere furnace for primary sintering, wherein the mixture was first sintered at 400° C. for 3 hours and then heated to 710° C. for sintering for 12 hours, at a heating rate of 5° C./min, and a matrix material was obtained after natural cooling; the sintered sample was passed through a 300-mesh sieve to obtain a primary sintered product, which was then water-washed; the prepared material, when washed, was stirred with an electric stirrer, washed in a ratio of 1:1 with deionized water for 30 minutes and then filtered, and the filter cake was placed in a vacuum drying oven for drying for 10 hours; after washing and drying, the sample was subjected to secondary sintering and then cooled naturally in an oxygen-atmosphere furnace at 600° C. for 6 hours, and the cooled sample was passed through a 300-mesh sieve to obtain a positive electrode material with a high compaction density.

### Example 5

A positive electrode active material with a combination of large and small particles, comprising large-particle secondary spheres and small-particle secondary spheres, wherein the chemical formula of the large-particle secondary spheres is Li_{1.03}Ni_{0.9}Co_{0.07}Al_{0.03}Zr_{0.0015}O₂ and the chemical formula of the small-particle secondary spheres is Li_{1.03}Ni_{0.925}Co_{0.045}Al_{0.03}W_{0.0015}Mg_{0.001}O₂, which was prepared by the following steps:
(1) A nickel sulfate solution and a cobalt sulfate solution were mixed, a sodium aluminate solution dissolved in a sodium hydroxide solution, a zirconium sulfate solution, an ammonia solution with a concentration of 0.2 mol/L, and a sodium hydroxide solution with a concentration of 5.5 mol/L were added and fed into a reactor at a rate of 2.5 L/h for reaction, with a pH of 11.5, a temperature of 55° C., and a stirring speed of 400 rpm during the reaction process, wherein the metal molar ratio of Ni to Co to Al was 0.9:0.07:0.03 and the molar weight of zirconium was 0.15 mol % of the total metal molar weight, and, after aging, centrifugation, and drying, a large-particle precursor with a D50 particle size of 14.5 μm was obtained. The small-particle precursor was synthesized by the same method as the large-particle precursor, but in the metal molar ratio of Ni to Co to Al being 0.91:0.07:0.02, a magnesium sulfate solution and a sodium tungstate solution were added in the preparation process, with element W having a molar weight of 0.15 mol % and element Mg having a molar weight of 0.1 mol %, wherein, when the D50 particle size reached 3.2 μm, the reaction was stopped and a small-particle precursor was obtained by post-treatment.
(2) Large-particle precursor Ni_{0.9}Co_{0.07}Al_{0.03}(OH)₂ doped with 0.15 mol % element Zr and small-particle precursor Ni_{0.925}Co_{0.045}Al_{0.03}(OH)₂ doped with 0.15 mol % element W and 0.1 mol % Mg were weighed in a mass ratio of 7:3, the two precursors were mixed with lithium hydroxide in a high-speed mixer in a metal molar ratio of 1:1.03, and the mixture was placed in an oxygen-atmosphere furnace for primary sintering, wherein the mixture was first sintered at 400° C. for 3 hours and then heated to 710° C. for sintering for 12 hours, at a heating rate of 5° C./min, and a matrix material was obtained after natural cooling; the sintered sample was passed through a 300-mesh sieve to obtain a primary sintered product, which was then water-washed; the prepared material, when washed, was stirred with an electric stirrer, washed in a ratio of 1:1 with deionized water for 30 minutes and then filtered, and the filter cake was placed in a vacuum drying oven for drying for 10 hours; after washing and drying, the sample was subjected to secondary sintering and then cooled naturally in an oxygen-atmosphere furnace at 550° C. for 6 hours, and the cooled sample was passed through a 300-mesh sieve to obtain a positive electrode material with a high compaction density.

### COMPARATIVE EXAMPLE 1

A positive electrode active material prepared by the following steps:

Large-particle precursor Ni_{0.9}Co_{0.08}Al_{0.02}(OH)₂ and small-particle precursor Ni_{0.91}Co_{0.07}Al_{0.02}(OH)₂ were weighed in a mass ratio of 7.5:2.5, the large particles having a D50 particle size of 14.5 μm, the small particles having a D50 particle size of 3.5 μm, the two precursors were mixed with lithium hydroxide in a high-speed mixer in a metal molar ratio of 1:1.04, and the mixture was placed in an oxygen-atmosphere furnace for primary sintering, wherein the mixture was first sintered at 400° C. for 3 hours and then heated to 720° C. for sintering for 12 hours, at a heating rate of 5° C./min, and a matrix material was obtained after natural cooling; the sintered sample was passed through a 300-mesh sieve to obtain a primary sintered product, which was then water-washed; the prepared material, when washed, was stirred with an electric stirrer, washed in a ratio of 1:1 with deionized water for 30 minutes and then filtered, and the filter cake was placed in a vacuum drying oven for drying for 10 hours; after washing and drying, the sample was subjected to secondary sintering and then cooled naturally in an oxygen-atmosphere furnace at 600° C. for 6 hours, and the cooled sample was passed through a 300-mesh sieve to obtain a positive electrode material with a high compaction density.

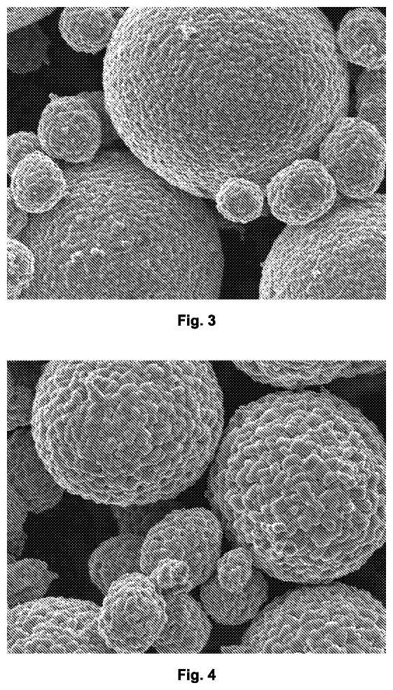

As shown in FIG. 3, the undoped large and small particles, after being sintered, had significantly different primary particle sizes.

### COMPARATIVE EXAMPLE 2

A positive electrode active material prepared by the following steps:

Large-particle precursor Ni_{0.9}Co_{0.05}Mn_{0.05}(OH)₂ and small-particle precursor Ni_{0.91}Co_{0.04}Mn_{0.05}(OH)₂ were weighed in a mass ratio of 7:3, the large particles having a D50 particle size of 14.5 μm, the small particles having a D50 particle size of 3.1 μm, the two precursors were mixed with lithium hydroxide in a high-speed mixer in a metal molar ratio of 1:1.03, and the mixture was placed in an oxygen-atmosphere furnace for primary sintering, wherein the mixture was first sintered at 400° C. for 3 hours and then heated to 750° C. for sintering for 12 hours, at a heating rate of 5° C./min, and a matrix material was obtained after natural cooling; the sintered sample was passed through a 300-mesh sieve to obtain a primary sintered product, which was then water-washed; the prepared material, when washed, was stirred with an electric stirrer, washed in a ratio of 1:1 with deionized water for 30 minutes and then filtered, and the filter cake was placed in a vacuum drying oven for drying for 10 hours; after washing and drying, the sample was subjected to secondary sintering and then cooled naturally in an oxygen-atmosphere furnace at 500° C. for 6 hours, and the cooled sample was passed through a 300-mesh sieve to obtain a positive electrode material with a high compaction density.

As shown in FIG. 4, the undoped large and small particles, after being sintered, had significantly different primary particle sizes.

### COMPARATIVE EXAMPLE 3

A positive electrode active material prepared by the following steps:
(1) A nickel sulfate solution, a cobalt sulfate solution, a manganese sulfate solution, a zirconium sulfate solution, an ammonia solution with a concentration of 0.15 mol/L, and a sodium hydroxide solution with a concentration of 6.0 mol/L were fed into a reactor at a certain rate for reaction, wherein the metal molar ratio was 0.9:0.05:0.05 and the zirconium solution had a molar weight of 0.15 mol %, and, after aging, centrifugation, and drying, a large-particle precursor with a D50 particle size of 14.0 μm was obtained. The small-particle precursor was synthesized by the same method as the large-particle precursor, but in a metal molar ratio of 0.91:0.04:0.05, a 0.15 mol % zirconium solution was added, the reaction was stopped when the D50 particle size reached 3.3 μm, and a small-particle precursor was obtained by post-treatment.
(2) Large-particle precursor Ni_{0.9}Co_{0.05}Mn_{0.05}(OH)₂ doped with 0.15 mol % element Zr and small-particle precursor Ni_{0.91}Co_{0.04}Mn_{0.05}(OH)₂ doped with 0.15 mol % element Zr were weighed in a mass ratio of 7:3, the two precursors were mixed with lithium hydroxide in a high-speed mixer in a metal molar ratio of 1:1.05, and the mixture was placed in an oxygen-atmosphere furnace for primary sintering, wherein the mixture was first sintered at 400° C. for 3 hours and then heated to 745° C. for sintering for 12 hours, at a heating rate of 5° C./min, and a matrix material was obtained after natural cooling; the sintered sample was passed through a 300-mesh sieve to obtain a primary sintered product, which was then water-washed; the prepared material, when washed, was stirred with an electric stirrer, washed in a ratio of 1:1 with deionized water for 30 minutes and then filtered, and the filter cake was placed in a vacuum drying oven for drying for hours; after washing and drying, the sample was subjected to secondary sintering and then cooled naturally in an oxygen-atmosphere furnace at 500° C. for 6 hours, and the cooled sample was passed through a 300-mesh sieve to obtain a positive electrode material with a high compaction density.

### COMPARATIVE EXAMPLE 4

A positive electrode active material with a combination of large and small particles, comprising large-particle secondary spheres and small-particle secondary spheres, wherein the chemical formula of the large-particle secondary spheres is Li_{1.04}Ni_{0.9}Co_{0.08}Al_{0.02}O₂ and the chemical formula of the small-particle secondary spheres is Li_{1.04}Ni_{0.91}Co_{0.07}Al_{0.02}O₂ (doped with an additional 0.1 mol % element W), which was prepared by the following steps:
(1) A nickel sulfate solution and a cobalt sulfate solution were mixed, a sodium aluminate solution dissolved in a sodium hydroxide solution, a sodium tungstate solution, an ammonia solution with a concentration of 0.2 mol/L, and a sodium hydroxide solution with a concentration of 5.5 mol/L were added and fed into a reactor at a certain rate for reaction, wherein the metal molar ratio was 0.91:0.07:0.02 and the molar weight of W was 0.1 mol %, and, after aging, centrifugation, and drying, a small-particle precursor with a D50 particle size of 3 μm was obtained. The large-particle precursor was synthesized by the same method as the small-particle precursor, but in a metal molar ratio of 0.90:0.08:0.02, no sodium tungstate solution was added in the preparation process, the reaction was stopped when the 050 particle size reached 14.5 μm, and a large-particle precursor was obtained by post-treatment.
(2) Large-particle precursor Ni_{0.9}Co_{0.08}Al_{0.02}(OH)₂ and small-particle precursor Ni_{0.91}Co_{0.07}Al_{0.02}(OH)₂ doped with 0.1 mol % element W were weighed in a mass ratio of 7.5:2.5, the two precursors were mixed with lithium hydroxide in a high-speed mixer in a metal molar ratio of 1:1.04, and the mixture was placed in an oxygen-atmosphere furnace for primary sintering, wherein the mixture was first sintered at 400° C. for 3 hours and then heated to 710° C. for sintering for 12 hours, at a heating rate of 5° C./min, and a matrix material was obtained after natural cooling; the sintered sample was passed through a 300-mesh sieve to obtain a primary sintered product, which was then water-washed; the prepared material, when washed, was stirred with an electric stirrer, washed in a ratio of 1:1 with deionized water for 30 minutes and then filtered, and the filter cake was placed in a vacuum drying oven for drying for 10 hours; after washing and drying, the sample was subjected to secondary sintering and then cooled naturally in an oxygen-atmosphere furnace at 600° C. for 6 hours, and the cooled sample was passed through a 300-mesh sieve to obtain a positive electrode material with a high compaction density.

### COMPARATIVE EXAMPLE 5

A positive electrode active material prepared by the following steps:

Large-particle precursor Ni_{0.9}Co_{0.05}Mn_{0.05}(OH)₂ and small-particle precursor Ni_{0.90}Co_{0.05}Mn_{0.05}(OH)₂ were weighed in a mass ratio of 7:3, the large particles having a D50 particle size of 14.0 μm, the small particles having a D50 particle size of 3.0 μm, the two precursors were mixed with lithium hydroxide in a high-speed mixer in a metal molar ratio of 1:1.03, and the mixture was placed in an oxygen-atmosphere furnace for primary sintering, wherein the mixture was first sintered at 400° C. for 3 hours and then heated to 750° C. for sintering for 12 hours, at a heating rate of 5° C./min, and a matrix material was obtained after natural cooling; the sintered sample was passed through a 300-mesh sieve to obtain a primary sintered product, which was then water-washed; the prepared material, when washed, was stirred with an electric stirrer, washed in a ratio of 1:1 with deionized water for 30 minutes and then filtered, and the filter cake was placed in a vacuum drying oven for drying for 10 hours; after washing and drying, the sample was subjected to secondary sintering and then cooled naturally in an oxygen-atmosphere furnace at 500° C. for 6 hours, and the cooled sample was passed through a 300-mesh sieve to obtain a positive electrode material with a high compaction density.

TABLE 1
Comparison of the performance of positive electrode materials
in embodiments 1-5 and comparative examples 1-5

| | | | Room- | High- | |
|---|---|---|---|---|---|
| | | | temper- | temper- | 70% |
| | Charging | Discharge | ature | ature | SOC |
| | capacity | capacity | cycling | cycling | DCR |
| | (mAh/g) | (mAh/g) | (%) | (%) | (Ω) |
| Comparative | 238.3 | 213.2 | 93.1 | 91.3 | 18.3 |
| example 1 | | | | | |
| Comparative | 241.1 | 218.6 | 94.2 | 93.8 | 19 |
| example 2 | | | | | |
| Comparative | 242.3 | 219.4 | 94.3 | 93.1 | 20.1 |
| example 3 | | | | | |
| Comparative | 239.7 | 215.9 | 93.9 | 92.2 | 16.9 |
| example 4 | | | | | |
| Comparative | 241.3 | 217.6 | 94.2 | 93.3 | 21.4 |
| example 5 | | | | | |
| Embodiment 1 | 238.6 | 214.3 | 94.1 | 91.9 | 17.3 |
| Embodiment 2 | 242.6 | 220.3 | 95.8 | 94.3 | 18.3 |
| Embodiment 3 | 237.5 | 216.4 | 94.1 | 92.2 | 15.6 |
| Embodiment 4 | 237.9 | 217.8 | 94.2 | 92.8 | 16.1 |
| Embodiment 5 | 239.5 | 216.3 | 95.4 | 92.9 | 16.9 |

A comparison of the performance of the positive electrode materials in embodiments 1-5 and comparative examples 1-5 is listed in Table 1. The above results show that, in the comparative examples, due to the inability to accurately control the temperature required for sintering large and small particles during the co-sintering process, the overall performance of the sintered secondary sphere products failed to reach the optimal level; in the embodiments, different elements were doped in the precursor stage so that the sizes of primary particles of the materials were controllable and the requirement that large and small particles have the same sintering temperature was indirectly met during the co-sintering process, so all the materials obtained by co-sintering suitable large and small particles delivered higher performance. In embodiment 2, large and small particles were doped with different elements, so embodiment 2 had improved capacity and cycling performance compared with comparative example 2; similar results may also be observed in embodiment 3 and comparative example 3. It is thus clear that, compared with the comparative examples, embodiments 1-5 achieved more significant performance improvements, because the large and small particles were simultaneously doped with suitable elements, which is conducive to achieving further performance improvement. In addition, the large and small particles in comparative example 5 had the same Ni content, so the DCR of this example was higher than other test results.

1. A positive electrode active material with a combination of large and small particles, wherein the positive electrode active material comprises large-particle secondary spheres and small-particle secondary spheres, and wherein a mass ratio of the large-particle secondary spheres in the positive electrode active material is not smaller than 50%;
wherein:
a chemical formula of the large-particle secondary spheres is LiₐNi_{b}M_{c}M′_{d}O₂, wherein M is one or more of Co, Mn, and Al, M′ is a doping element, and M′ is selected from the group consisting of one or more of Zr and Sr, 0.9≤a≤1.2, 0.7≤b<1, 0<c≤0.3, 0<d≤0.1;
a chemical formula of the small-particle secondary spheres is LiₑNi_{f}M_{g}M″ₕO₂, wherein M is one or more of Co, Mn, and Al, M″ is a doping element, and M″ is selected from the group consisting of one or more of B, W, Mo, In, Ta, and S, 0.9≤e≤1.2, 0.7≤f<1, 0<g≤0.2, 0<h≤0.1; and
a D50 particle size of the large-particle secondary spheres is 10-20 μm, and a D50 particle size of the small-particle secondary spheres is 2-5 μm.

2. The positive electrode active material with a combination of large and small particles according to claim 1, wherein a mass ratio of the large-particle secondary spheres to the small-particle secondary spheres is (7:3)-(9:1).

3. The positive electrode active material with a combination of large and small particles according to claim 1, wherein the f and b satisfy conditions: f>b, and f−b<0.1.

4. The positive electrode active material with a combination of large and small particles according to claim 1, wherein the positive electrode active material is obtained by mixing and then co-sintering a precursor of the large-particle secondary spheres and a precursor of the small-particle secondary spheres, with doping elements M′ and M″ added during a preparation process of the precursor.

5. A preparation method of the positive electrode active material with a combination of large and small particles according to claim 1, wherein the method comprises steps of:
(1) mixing metal-salt solutions corresponding to the large-particle secondary spheres and the small-particle secondary spheres respectively with the metal-salt solutions corresponding to a precipitant, a complexing agent, and a doping element for a coprecipitation reaction, and then filtering and drying the mixture to prepare a large-particle secondary sphere precursor containing the doping element M′ and a small-particle secondary sphere precursor containing the doping element M″, respectively; and
(2) mixing the large-particle secondary sphere precursor and the small-particle secondary sphere precursor with a lithium source to obtain a mixture, and sintering the mixture to obtain a positive electrode active material with the combination of large and small particles.

6. The preparation method according to claim 5, wherein, in step (1), all of the metal-salt solutions corresponding to the large-particle secondary spheres and the small-particle secondary spheres comprise a nickel salt and an M salt; the precipitant comprises one or more of sodium hydroxide and potassium hydroxide; and the complexing agent comprises one or more of ammonia solution, ammonium sulfate, and ammonium bicarbonate.

7. The preparation method according to claim 5, wherein, in step (1), the conditions for the coprecipitation reaction are that all of the metal-salt solutions are added to a reaction vessel at a rate of 0.1-10 L/h, with a pH of 9-12, a temperature of 40-80° C., and a stirring speed of 300-600 rpm during a reaction process.

8. The preparation method according to claim 5, wherein, in step (2), the lithium source is selected from the group consisting of one or more of lithium carbonate, lithium hydroxide, and lithium nitrate; and a molar ratio of metal elements in the lithium source to the total metal elements in the precursors of large and small secondary spheres is (0.9-1.2):1.

9. The preparation method according to claim 5, wherein, in step (2), the sintering has a temperature of 500-1000° C.

10. The preparation method according to claim 9, wherein the sintering comprises steps of:
S1, placing the mixture in an oxygen atmosphere for primary sintering, first sintering the mixture at 400-550° C. for 1-3 hours, then heating the mixture up at 1-5° C./min to 600-800° C. for sintering for 8-20 hours, and, after cooling, passing the mixture through a 300-mesh sieve to obtain a primary sintered product;
S2, washing, filtering, and drying the primary sintered product, placing the primary sintered product in an oxygen atmosphere for a second sintering, with a sintering temperature of 300-700° C. and a holding time of 3 hours, and, after cooling, passing the primary sintered product through a 300-mesh sieve to obtain a positive electrode active material with a combination of large and small particles.
